(19) United States
(12) Patent Application Publication
(10) Pub. No.: US 2017/0026368 A1
(43) Pub. Date: Jan. 26, 2017

(54) Portable Device with Bio-Security Code Generating Module

(71) Applicants: Mei Ling LO, Taipei (TW); Kuo-Ching CHIANG, Taipei (TW)

(72) Inventors: Mei Ling LO, Taipei (TW); Kuo-Ching CHIANG, Taipei (TW)

(21) Appl. No.: 15/285,480

(22) Filed: Oct. 4, 2016

Related U.S. Application Data
(62) Division of application No. 14/108,363, filed on Dec. 17, 2013.

(51) Int. Cl. H04L 29/06; G06K 9/00

(52) U.S. Cl. CPC H04L 63/0861; H04L 63/10; G06K 9/00604; G06K 9/00617

(57) ABSTRACT

A mobile phone comprises a control unit; a wireless communication module coupled to the control unit; a display coupled to the control unit; an eye light source formed on the mobile phone for projecting a light to at least one user's eye; an eye sensor formed on the mobile phone for receiving light back from the at least one user's eye to generate an eye image; a bio-security code generator for generating a template of a user as a bio-security code; and a bio-security code recognition module for comparing the bio-security code with the captured eye image.

### CROSS REFERENCE TO RELATED APPLICATIONS

This application is a divisional application of Ser. No. 14/108,363, filed on Dec. 17, 2013, which is pending, and the content of the above-mentioned patent applications is hereby incorporated by reference herein in its entirety and made a part of this specification.

### TECHNICAL FIELD

The present invention relates generally to an electronic device, and more particularly to a security method for smart phone.

### BACKGROUND OF RELATED ARTS

Telecommunication and internet follow the tread to develop more convenient product and service to the market. The communication is, therefore, booming day by day. The network, mobile device are the essential facility and device for the human daily life. The network service provider and device maker are continuously to offer better service and solution to the user. The number of devices that individuals use for communications and messaging has also multiplied. Such devices include computers, wireless phones or tablet. The electronic mail is a method of exchanging digital messages. Modern email operates across the Internet or other networks. Email servers accept, forward, deliver, and store messages. The device may coupes remote or local terminal mail system. Service providers are drivers that connect client applications to a messaging system. For example, MAPI service providers include: message store providers, address book or directory providers, and message transport providers. The service providers work with MAPI to create and send messages. When the client sent the message, the message store provider will check recipient that has valid address. Address book providers handle access to directory information. For example, address book providers store a recipient's name, address, and address type. Transport providers handle message transmission and reception. When an incoming message is detected, the transport provider informs the spooler and the message is delivered to the appropriate message store. To handle outgoing messages, the message store moves the message to the outbound queue, and the spooler transfers it to the appropriate transport providers. The first thing before logging the mail system is to enter the password and account name. However, the current electronic mail system is based on text. It is not convenient to the user.

### SUMMARY

A method of accessing an e-mail system includes steps of preparing a template by capturing a first bio-characteristic of a user by a bio-characteristic capturing device of a computing device, followed by storing the first bio characteristic in the computing device or in a remote server. The next step is to activate an e mail system from the computing device; triggering the bio-characteristic capturing device of the computing device to capture a second bio-characteristic of the user; comparing the captured second bio-characteristic of the user with the first bio characteristic in the computing device or in the remote server. The system will allow the user access the e mail system when the second bio-characteristic matches with the first bio characteristic. The first bio-characteristic is replaced by the second bio characteristic to refresh a template.

The first bio characteristic is replaced by the second bio characteristic to refresh a template. The template includes fingerprint, eye image or face image. The bio-characteristic capturing device includes image sensor or microphone.

The template includes voiceprint; the bio-characteristic capturing device includes microphone.

Address book providers handle access to directory information. Message store providers handle the storage and retrieval of messages and other information for the users of client application.

The first bio characteristic is replaced by the second bio characteristic to refresh a template. The template includes fingerprint, eye image or face image. The bio-characteristic capturing device includes image sensor or microphone.

A mobile phone comprises a control unit; a wireless communication module coupled to the control unit; a display coupled to the control unit; an eye light source formed on the mobile phone for projecting a light to at least one user's eye; an eye sensor formed on the mobile phone for receiving light back from the at least one user's eye to generate an eye image; a bio-security code generator for generating a template of a user as a bio-security code; and a bio-security code recognition module for comparing the bio-security code with the captured eye image.

When the captured eye image matches with the template as comparing the bio-security code with the captured eye image by the bio-security code recognition module, logging in a remote web system.

When the captured eye image matches with the template as comparing the bio-security code with the captured eye image by the bio-security code recognition module, accessing a remote server in the mobile phone.

When the captured eye image matches with the template as comparing the bio-security code with the captured eye image by the bio-security code recognition module, accessing a local system of the mobile phone.

### BRIEF DESCRIPTION OF THE DRAWINGS

FIG. 1 shows a diagram of a computing system according to the present invention.

FIG. 2 shows a flow chart for accessing the e-mail system according to the present invention.

### DETAILED DESCRIPTION

The present invention relates generally to an electronic mail system. The portable device includes but not limited to cellular phone, PDA (personal digital assistant), smart phone, notebook, tablet and the equivalent thereof. The wireless communication portable device may include dual-way transmission protocol, such as GSM, CDMA or WCDMA, 4G. Alternatively, the transmission protocol includes WiFi protocol.

The present invention relates to electronic mail system. It can be applied to any suitable e-mail module, for instance, Microsoft Outlook, web mail system such as Google mail, hot mail, yahoo mail and any other web mail system. In one embodiment, the electronic mail system is incorporate with computing platform and operation system. Under such scheme, the electronic mail module may be utilized by the user for transmitting, receiving electronic mail. The electronic mail system includes pluralities of sub-modules, for example, including a calendar manager, a task list manager, a contact manager, a message manager (e-mail), and a notes manager. Although the preferred embodiment will be generally described in the context of a program and an operating system running on a personal computer, table, smart phone those skilled in the art will recognize that the present invention also can be implemented in conjunction with other program modules for other types of computers, or operation system Android, iOS.

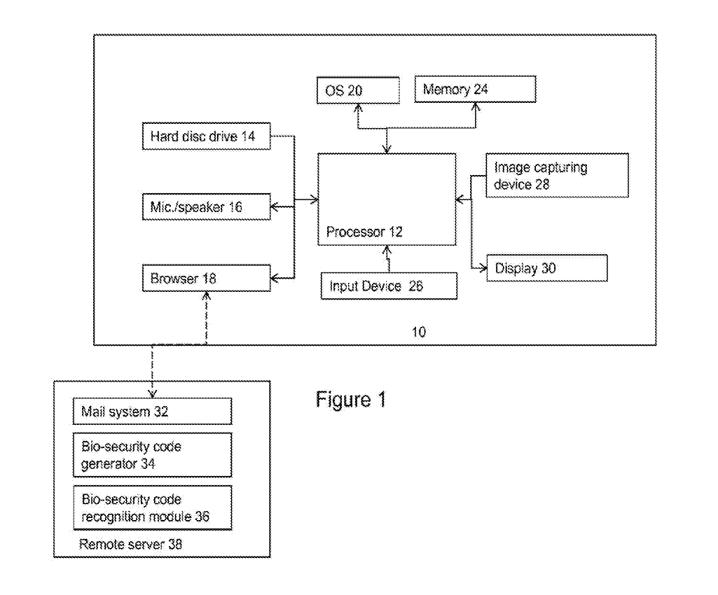

The electronic mail system is developed over ten years. However, these messages are simple text messages and are presented by text. The computing generally includes CPU, memory, display, I/O etc. The present invention may be applied to the heterogeneous distributed computing environment, for instance, remote server. As shown in FIG. 1, the computing device 10 such as computer, note book, tablet, smart phone, includes a processing unit 12 and memory 24, which is coupled to the processing unit 12. The computing device 10 may have BIOS which is a set of basic routines to transfer information between elements within the computing device 10. Those skilled in the art will also appreciate that the present invention may be used for computing devices without BIOS. A hard disk drive 14 is coupled to the processing unit 12. Some of the computing devices omit the hard drive. A user inputs instruction to the computing device 10 via input devices 26, such as a keyboard, mouse or touch screen. A display 30 is connected to the processing unit 14. OS 20 and applications 18 such as browser are stored on the computer readable medium. Microphone and speaker 16 are coupled to the processing unit 14, an image capturing device 28 is also coupled to the processing unit 14.

An Internet email message consists of three components, the message envelope, the message header, and the message body. The message header contains control information, including, minimally, an originator's email address and one or more recipient addresses. Usually descriptive information is also added. Messages are exchanged between hosts using the Simple Mail Transfer Protocol with software programs; and delivered to a mail store by programs called mail delivery agents. Users can retrieve their messages from servers using standard protocols such as POP or IMAP. Webmail interfaces allow users to access their mail with any standard web browser, from any computer, rather than relying on an email client. mail user agents (MUAs) used by users is provided for retrieving, reading, and managing email. Mail can be stored on the client, on the server side, or in both places. Server-side storage is often in a proprietary format but since access is through a standard protocol such as IMAP, moving email from one server to another can be done with any MUA supporting the protocol.

Web-based email (webmail) is the type of email. Many free email providers host their servers as web-based email (e.g. Hot Mail, Gmail, Outlook and Yahoo! Mail). This allows users to log into the email account by using a web browser to send and receive their email. POP3 is the acronym for Post Office Protocol 3. It is a leading email account type on the Internet. In a POP3 email account, email messages are downloaded to the client device and then they are deleted from the mail server. Other protocols IMAP, (Internet Message Access Protocol) provide more complete and complex remote access to typical mailbox operations. Another protocol is called Messaging Application Programming Interface (MAPI). The MAPI architecture is designed to make it easy for programmers to write messaging-enabled applications that are independent of the underlying messaging system. MAPI provides high-level function that can be used to implement sophisticated messaging features with a relatively small amount of code. The code deals with functions, for example, sending, receiving, and addressing messages. The underlying messaging system is completely transparent. Those skilled in the art will recognize that the present invention may be applied to any operation system and any mail protocol.

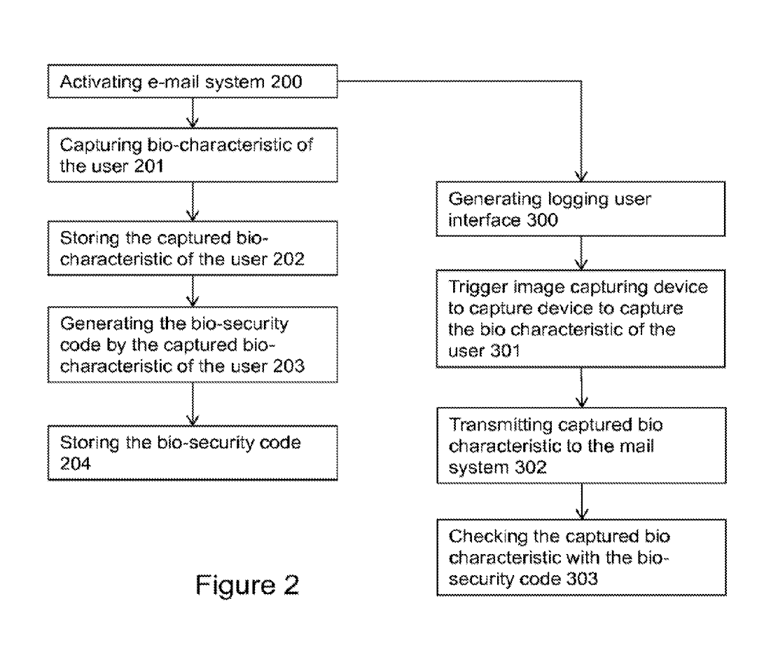

The present invention includes a step of activating the mail system 200 from the user terminal device 10. The mail system may be a local mail system or web-based mail system as shown in FIG. 2. The next is to prepare the security code for logging the mail system. In one embodiment, the invention introduces the bio-characteristic as the security code instead of text based password. The mail system activates the device to collect the bio-characteristic of the user. The bio characteristic includes face image, eye image, fingerprint or voice bio-characteristic. The face image, eye image, fingerprint bio-characteristic can be captured by image capturing device 28, the voice bio-characteristic is collected by microphone 16. After the template of the bio-characteristic is collected, the bio-characteristic is stored in local system or remote system 202, thereby generating the bio-security code by the bio-security code generator 34 in step 203. Then, the bio-security code is stored in local system or remote system.

If the user would like to send or receive e mail from the mail system 32 in the server 38, please refer to FIG. 2. After the user activates the mails system, the mail system 38 generates and transmits the user interface to the user terminal and displayed on the display 30 in step 300. The user bio-characteristic is captured by the image capturing device 28 or the microphone 16 in step 301. The user may not input the password and the user account due to the user oneself is actually the real “user account” and “password”. The captured bio-characteristic is transmitted to the mail system in the remote server or local system in step 302, followed by compare the stored bio-security code with the currently captured bio-characteristic by the bio-security code recognition module 36 in the remote server 38 in step 303. Preferably, dual source LED is used to project two spatially separated spots at the subject's pupil. The dual source LED is constructed by placing two LED side by side on the panel of the portable device. Back light from the subject's eye is detected by a sensor directly or via other optical mirror or lens. Another method is to detect the user image by the sensor. The sensor could be optical sensor such as CMOS sensor or CCD.

The method associated with the present invention includes the steps of activating the e-mail system. The electronic system includes text, or audio/video e-mail generator. The next step is to activate the e-mail generator to generate the e-mail, followed by triggering at least one of the microphone and digital camera or the like. The next step is to generate and prepare the text, audio/video e-mail by the text, or audio/video e-mail generator. Then, the user may transmit the text, or audio/video e-mail. A message store provider initiates the sending process, and delivers it to the appropriate transport provider. The transport provider gives the message to its messaging system, which sends it to the intended recipient(s). When the user opens the e-mail, it displays by the audio/video type instead of conventional text. The receiver may receive the audio message through the output of the speaker and the video signal is displayed on the display. Accordingly, the text message may be shown on the display as well. When the user would like to send the text, audio/video e-mail and input the instruction of creating a new mail, the user may initiate the generation of audio/video mail, then inputs the receipt address, or vice versa. The mentioned method above may be employed for the instant chat application for the logging.

Therefore, the e-mail system (instant chat application) is different from the prior message system. The method can be used in local mail system, web mail system, instant message system. Alternatively, the present invention may be integrated into the mobile phone terminal, table or PDA, thereby allowing the user may receive the message portably, and the user may omit to input the text word or message by one hand. The user may input the message by voice and/or video. If the system is based on the web base, the user may couple to the web mail service provider through the browser before receiving or sending mails. As mentioned, the wireless communication portable device may include dual-way transmission protocol, such as GSM, CDMA or 4G. However, if the video data is required to be received and transmitted, simultaneously, the mobile communication protocol is well-known to be at least third generation mobile protocol, such as WCDMA or higher. From above, the mobile phone with at least third generation mobile protocol and the message generator comprises the e-mail generator provided to generate an e-mail or instant message. The message is processed by said generator and transmitted and received by said at least third generation mobile protocol. The present invention may allow the user portably receive the e-mail without inputting the text based password.

If the mobile phone includes internet work linking capability, namely, it integrated WLAN module into the device, it may couple to the network through the network linking module, for example WiFi, WiMax, 802.11 standard. The present invention changes the type of password. It provides better communication interface. Therefore, the user may send a true “password” by bio-characteristics. Thus, it offers better security interface for the user to login the message system. It also may allow the blind people to send a voice mail (message) even if he cannot see the keyboard or touch screen. When the user activates the message or e-mail system, the bio-characteristic capturing device will be triggered to automatically fetch the current bio-characteristic of the user, followed by accessing the message or mail system when the system identifies the user. Further, the user may refresh the template by using new captured bio-characteristic. The bio-characteristic may be changed due to the user gets older, for example, the face image maybe changed. Alternatively, the system maybe set to automatically alter the old bio-characteristic template by new captured bio-characteristic within one predetermined cycle.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A mobile phone, comprising:
a control unit;
a wireless communication module coupled to said control unit;
a display coupled to said control unit;
an eye light source formed on said mobile phone for projecting a light to at least one user's eye;
an eye sensor formed on said mobile phone for receiving said light back from said at least one user's eye to generate an eye image;
a bio-security code generator for generating a template of a user as a bio-security code; and
a bio-security code recognition module for comparing said bio-security code with said captured eye image.

2. The mobile phone according to claim 1, when said captured eye image matches with said template as comparing said bio-security code with said captured eye image by said bio-security code recognition module, logging in a remote web system.

3. The mobile phone according to claim 1, when said captured eye image matches with said template as comparing said bio-security code with said captured eye image by said bio-security code recognition module, accessing a remote server in said mobile phone.

4. The mobile phone according to claim 1, wherein said eye sensor comprises at least one image sensor, wherein said at least one image sensor comprises CMOS or CCD.

5. The mobile phone according to claim 1, wherein said wireless communication module is WiFi module.

6. The mobile phone according to claim 1, further comprising an input device coupled to said control unit.

7. The mobile phone according to claim 1, further comprising a memory coupled to said control unit.

8. The mobile phone according to claim 1, further comprising a hard disk drive coupled to said control unit.

9. The mobile phone according to claim 1, further comprising a browser coupled to said control unit.

10. The mobile phone according to claim 1, wherein said eye sensor is an image capturing device coupled to said control unit.

11. A mobile phone, comprising:
a control unit;
a wireless communication module coupled to said control unit;
a display coupled to said control unit;
an eye light source formed on said mobile phone for projecting a light to at least one user's eye;
an eye sensor formed on said mobile phone for receiving said light back from said at least one user's eye to generate an eye image;
a bio-security code generator for generating a template of a user as a bio-security code; and
a bio-security code recognition module for comparing said bio-security code with said captured eye image;
when said captured eye image matches with said template as comparing said bio-security code with said captured eye image by said bio-security code recognition module, accessing a local system of said mobile phone.

12. The mobile phone according to claim 11, wherein said eye sensor comprises at least one image sensor, wherein said at least one image sensor comprises CMOS or CCD.

13. The mobile phone according to claim 11, wherein said template is fetched by said an image capturing device.

14. The mobile phone according to claim 11, wherein said wireless communication module is WiFi module.

15. The mobile phone according to claim 11, wherein said wireless communication module is WiMax module or 802.11 standard module.

16. The mobile phone according to claim 11, further comprising an input device coupled to said control unit.

17. The mobile phone according to claim 11, further comprising a memory coupled to said control unit.

18. The mobile phone according to claim 11, further comprising a hard disk drive coupled to said control unit.

19. The mobile phone according to claim 11, further comprising a browser coupled to said control unit.

20. The mobile phone according to claim 11, wherein said eye sensor is an image capturing device coupled to said control unit.
